(19) United States
(12) Patent Application Publication
(10) Pub. No.: US 2015/0082269 A1
(43) Pub. Date: Mar. 19, 2015

(54) CLOUD SERVER AND METHOD FOR PROGRAMMING THREE-DIMENSIONAL MEASUREMENT OF PRODUCT OFF-LINE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); HENG ZHANG, Shenzhen (CN)

(21) Appl. No.: 14/484,512

(22) Filed: Sep. 12, 2014

(30) Foreign Application Priority Data
Sep. 13, 2013 (CN) 2013104185657

(51) Int. Cl. G06F 9/44

(52) U.S. Cl. CPC G06F 8/70
USPC 717/101

(57) ABSTRACT

In a method for programming a three-dimensional (3D) measurement of a product off-line using a cloud server, the cloud server connects to programming computers and a verification computer. The method generates programming tasks of the product according to a 3D drawing and a dimension figure of the product, and assigning the programming tasks to the programming computers for programming the product offline to generate dimension programs. The method displays an eligible dimension program with a first color on the programming computer and updating a programming progress of the programming task to the verification computer, and displays an ineligible dimension program with a second color on the programming computer and generates a notice indicating that the programming task needs to be reprogrammed. The dimension programs to are generate integrated a 3D coordinate measurement program of the product when all the programming tasks are accomplished.

### CROSS-REFERENCE TO RELATED APPLICATIONS

This application claims priority to Chinese Patent Application No. 201310418585.7 filed on Sep. 13, 2013, the contents of which are incorporated by reference herein.

### FIELD

The present disclosure relates to an assembly mechanism for three-dimensional (3D) measuring technique, and particularly to a cloud server and a method for programming a 3D measurement of a product off-line.

### BACKGROUND

More recently, three-dimensional (3D) measuring equipments have a high precision and a high speed in measuring physical dimensions and geometric tolerances of a product. Normally, for the purpose of measuring physical dimensions and geometric tolerances of the product with a high precision and a high speed, a 3D measuring program is programmed for the product finished in a computer and installed in a 3D measuring equipment. In this way, it is time consuming for users to program the 3D measuring equipment and amend the 3D measuring program of the product in the computer.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an example embodiment of a cloud server.

FIG. 2 is a flowchart of an example embodiment of a method for programming a 3D measurement of a product off-line.

FIG. 3 shows a plan view of example of a 3D drawing of a product.

FIG. 4 shows a plan view of example of a 2D dimension figure of the product.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

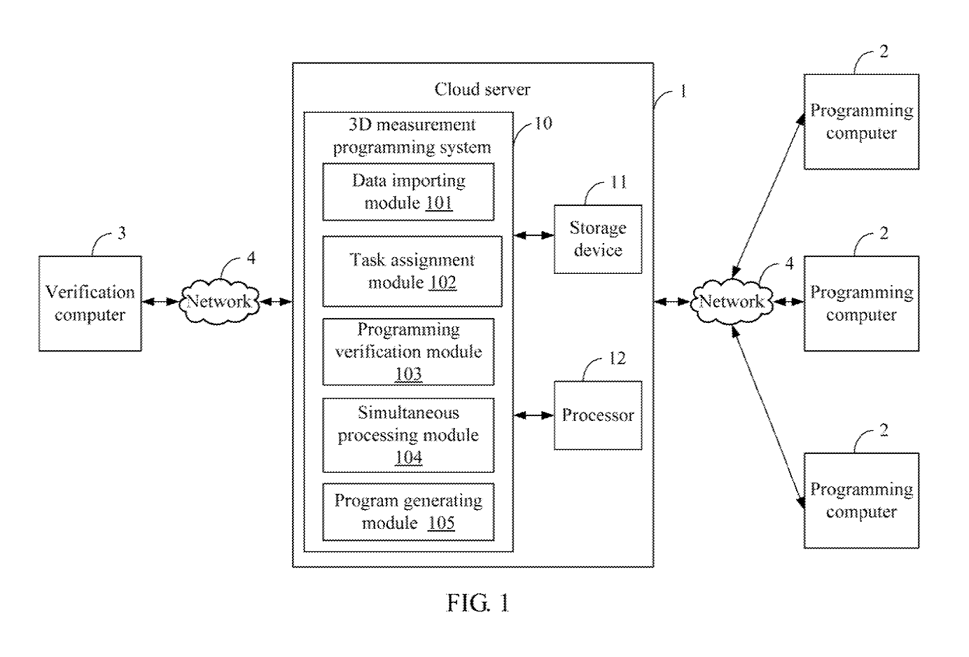

FIG. 1 illustrates a block diagram of an example embodiment of a cloud server 1. In the embodiment, the cloud server 1 can include, but is not limited to, a three-dimensional (3D) measurement programming system 10, a storage device 11, and at least one processor 12. In one embodiment, the cloud server 1 can be a server computer, a workstation computer, or any other suitable computing device. The 3D measurement programming system 10 comprises various modules including computerized instructions in the form of one or more computer-readable programs that can be stored in the storage device 11, and are implemented by the at least one processor 12 of the cloud server 1. FIG. 1 illustrates only one example of the cloud server 1, and other examples can comprise more or fewer components than those shown in the embodiment, or have a different configuration of the various components.

The cloud server 1 connects to a plurality of programming computers 2 and a verification computer 4 through a network. Each of the programming computers 2 and the verification computer 3 can be personal computers, notebook computers, or any other suitable computing devices. The network 4 can be a local area network (LAN) or a wide area network (WAN), such as an intranet or the Internet.

In one embodiment, the storage device 11 can be an internal storage system, such as a flash memory, a random access memory (RAM) for temporary storage of information, and/or a read-only memory (ROM) for permanent storage of information. The storage device 11 can also be an external storage system, such as an external hard disk, a storage card, or a data storage medium. The at least one processor 12 can be a central processing unit (CPU), a microprocessor, or other data processing chip that can perform various functions of the cloud server 1.

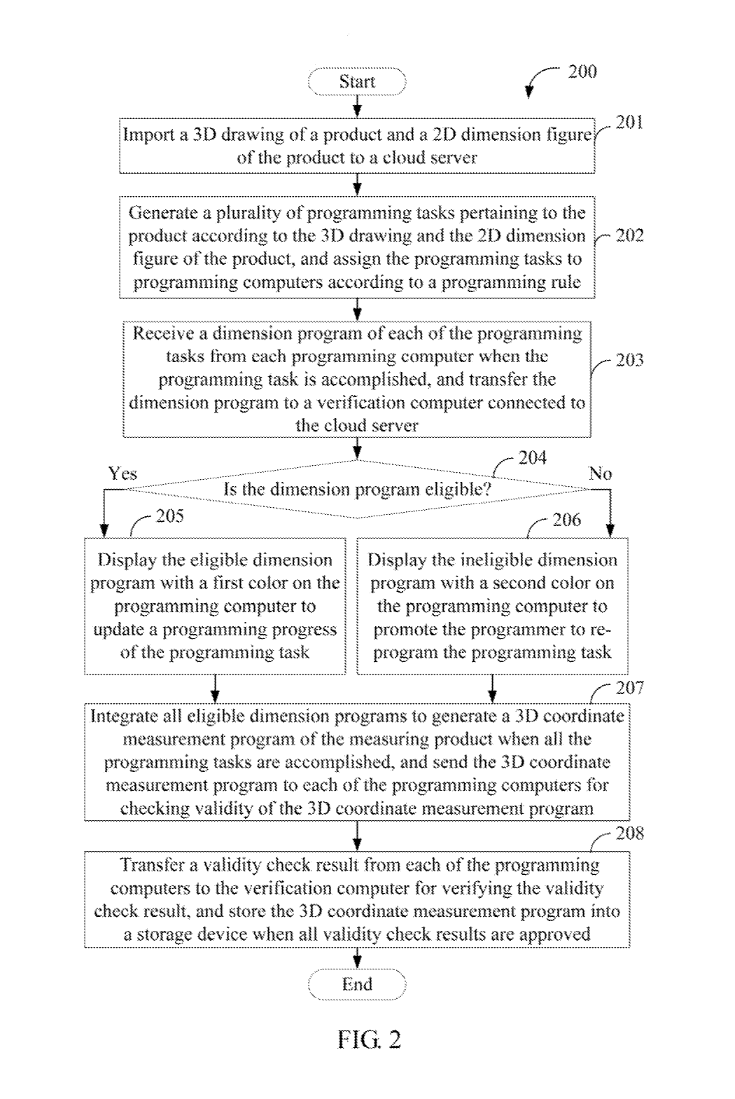

In the embodiment, the 3D measurement programming system 10 can comprise, but is not limited to, a data importing module 101, a task assignment module 102, a programming verification module 103, a simultaneous processing module 104, and a program generating module 105. The modules 101-105 can comprise computerized instructions in the form of one or more computer-readable programs that can be stored in a non-transitory computer-readable medium, such as the storage device 11, and be executed by the at least one processor 12 of the cloud computer 1. The modules 101-106 can be include the computerized instructions to execute the method as described below in relation to FIG. 2.

FIG. 2 illustrates a flowchart of an example embodiment of a method for programming a 3D measurement of a product off-line. In the example embodiment, the method 200 is performed by execution of computer-readable software program codes or instructions by at least one processor of a computing device, such as the cloud server 1 of FIG. 1. In the embodiment, the example method 200 is provided by way of example only as there are a variety of ways to carry out the method. The method 200 described below can be carried out using the configurations illustrated in FIG. 1, for example, and various elements of the figure are referenced in explaining the example method 200. Each block shown in FIG. 2 represents one or more processes, methods or subroutines, carried out in the exemplary method 200. Additionally, the illustrated order of blocks is by example only and the order of the blocks can be changed according to the present disclosure. The exemplary method 200 can begin at block 201.

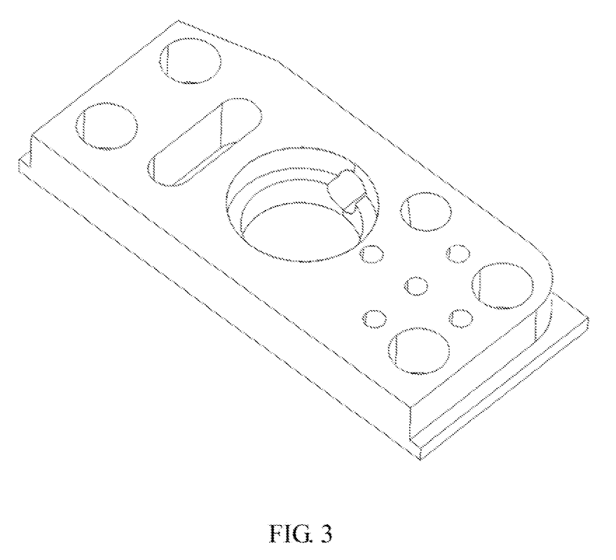

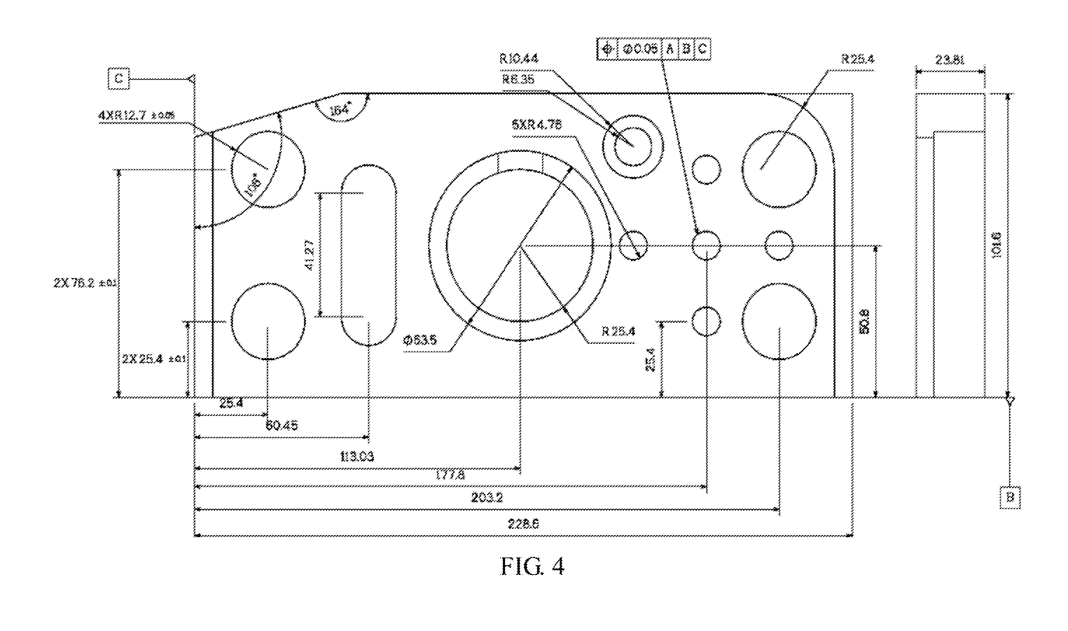

At block 201, a data importing module imports a 3D drawing of a product and a 2D dimension figure of the product to the cloud server 1. In one embodiment, the 3D drawing and the 2D dimension figure of the product can be stored in the storage device 11, or obtained from the product measured by a 3D measuring equipment. The product can be a motherboard of a computer to be measured by a 3D measuring equipment, for example. The 3D drawing of the product can be shown in FIG. 3, and the 2D dimension figure of the product can be shown in FIG. 4. Referring to FIG. 4, the product can be include a plurality of components in form of various shapes, such as circles, squares, rectangles, curves, and cylinders, for example. Each of figures has dimensions, such as the diameter of a circle φ=53.5 mm, the length of a rectangle L=101.6 mm, and the degree of a curve α=106°.

At block 202, a task assignment module generates a plurality of programming tasks pertaining to the product according to the 3D drawing and the 2D dimension figure of the product, and assigns the programming tasks to the programming computers 2 for programming the product offline according to a programming rule. In the embodiment, the programming rule defines that the 2D dimension figure is divided into a plurality of programming portions according to the dimensions of each component shape. Referring to FIG. 4, the 2D dimension figure of the product is divided into three programming portions, such as A portion, B portion, and C portion. Each of the programming portions is determined as a programming task, and is sent to a programming computer 2 to be programmed by a programmer.

At block 203, a programming verification module receives a dimension program of each of the programming tasks from each of the programming computers 2 when the programming task is accomplished by the programmer, and transfers the dimension program to a verification computer 3 through the network 4. When the verification computer 3 receives a dimension program from the programming computer 2 through the network 4, the programming verification module checks the validity of the dimension program according to the dimension figure of the product.

At block 204, the programming verification module determines whether the dimension program is eligible according to the dimension figure of the product. If the dimension program is eligible, block 205 is executed. Otherwise, if the dimension program is ineligible, block 206 is executed.

At block 205, a simultaneous processing module displays an eligible dimension program with a first color on the programming computer 2, and updates a programming progress of the programming task to the verification computer 3. In the embodiment, the simultaneous processing module marks the eligible dimension program using the first color, such as green or blue, and updates the programming progress of the programming task to the verification computer 3.

At block 206, the simultaneous processing module displays an ineligible dimension program with a second color on the programming computer 2, and generates a notice indicating that the programming task needs to be reprogrammed. In the embodiment, the simultaneous processing module marks the eligible dimension program using the second color, such as yellow or red, and prompts the programmer to reprogram the programming task on the programming computer 2.

At block 207, a program generating module integrates the eligible dimension programs to generate a 3D coordinate measurement program of the product when all the programming tasks are accomplished, and sends the 3D coordinate measurement program to each of the programming computers 2 for checking validity of the 3D coordinate measurement program. In the embodiment, the program generating module integrates all eligible dimension programs to generate the 3D coordinate measurement program of the product when the cloud server 1 receives the eligible dimension programs from the programming computers 2 through the network 4, and sends the 3D coordinate measurement program to each of the programming computers 2 through the network 4.

At block 208, the program generating module transfers a validity check result of the 3D coordinate measurement program from each of the programming computers 2 to the verification computer 3, and stores the 3D coordinate measurement program into the storage device 11 of the cloud server 1 when the validity check results from the programming computers 2 are approved by the verification computer 3. In the embodiment, the validity check result can include, but is not limited to, a dimension of each component of the product, a measurement path for measuring the product, and a collision simulation for measuring the product.

All of the processes described above may be embodied in, and fully automated via, functional code modules executed by one or more general purpose processors of computing devices. The code modules may be stored in any type of non-transitory readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A cloud server connected to a plurality of programming computers and a verification computer, the cloud server comprising:
at least one processor, and
a storage device storing a computer-readable program comprising instructions that, when executed by the at least one processor, cause the at least one processor to:
generate a plurality of programming tasks pertaining to a product according to a three-dimensional (3D) drawing and a dimension figure of the product;
assign the programming tasks to the programming computers for programming the product off-line to generate a plurality of dimension programs;
display an eligible dimension program of a programming task with a first color on the programming computer and update a programming progress of the programming task to the verification computer;
display an ineligible dimension program of the programming task with a second color on the programming computer and generate a notice indicating that the programming task needs to be reprogrammed;
integrate the eligible dimension programs to generate a 3D coordinate measurement program of the product when all the programming tasks are accomplished;
send the 3D coordinate measurement program to each of the programming computers for checking validity of the 3D coordinate measurement program;
transfer a validity check result of the 3D coordinate measurement program from each of the programming computers to the verification computer; and
store the 3D coordinate measurement program into the storage device when the validity check results from the programming computers are approved by the verification computer.

2. The cloud server according to claim 1, wherein the computer-readable program further causes the at least one processor to import the 3D drawing of the product and the dimension figure of the product to the cloud server.

3. The cloud server according to claim 1, wherein the computer-readable program further causes the at least one processor to determine whether each of the dimension programs is eligible according to the dimension figure of the product.

4. The cloud server according to claim 1, wherein the computer-readable program further causes the at least one processor to receive a dimension program of each of the programming tasks from each of the programming computers when the programming task is accomplished by the programming computer, and transfer the dimension program to the verification computer through a network.

5. The cloud server according to claim 1, wherein the first color is green or blue, and the second color is yellow or red.

6. The cloud server according to claim 1, wherein the validity check result comprises a dimension of each component of the product, a measurement path for measuring the product, and a collision simulation for measuring the product.

7. A method for programming a 3D measurement of a product off-line using a cloud server, the cloud server connected to a plurality of programming computers and a verification computer, the method comprising:
generating a plurality of programming tasks pertaining to a product according to a three-dimensional (3D) drawing and a dimension figure of the product;
assigning the programming tasks to the programming computers for programming the product offline to generate a plurality of dimension programs;
displaying an eligible dimension program of a programming task with a first color on the programming computer and updating a programming progress of the programming task to the verification computer;
displaying an ineligible dimension program of the programming task with a second color on the programming computer and generating a notice indicating that the programming task needs to be reprogrammed;
integrating the eligible dimension programs to generate a 3D coordinate measurement program of the product when all the programming tasks are accomplished;
sending the 3D coordinate measurement program to each of the programming computers for checking validity of the 3D coordinate measurement program;
transferring a validity check result of the 3D coordinate measurement program from each of the programming computers to the verification computer; and
storing the 3D coordinate measurement program into a storage device of the cloud server when the validity check results from the programming computers are approved by the verification computer.

8. The method according to claim 7, further comprising:
importing the 3D drawing of a product and the dimension figure of the product to the cloud server.

9. The method according to claim 7, further comprising:
determining whether each of the dimension programs is eligible according to the dimension figure of the product.

10. The method according to claim 7, further comprising:
receiving a dimension program of each of the programming tasks from each of the programming computers when the programming task is accomplished by the programming computer, and transferring the dimension program to the verification computer through a network.

11. The method according to claim 7, wherein the first color is green or blue, and the second color is yellow or red.

12. The method according to claim 7, wherein the validity check result comprises a dimension of each component of the product, a measurement path for measuring the product, and a collision simulation for measuring the product.

13. A non-transitory storage medium having stored thereon instructions that, when executed by at least one processor of a cloud server, causes the least one processor to execute instructions of a method for programming a three-dimensional (3D) measurement of a product off-line, the cloud server connected to a plurality of programming computers and a verification computer, the method comprising:
generating a plurality of programming tasks pertaining to a product according to a three-dimensional (3D) drawing and a dimension figure of the product;
assigning the programming tasks to the programming computers for programming the product offline to generate a plurality of dimension programs;
displaying an eligible dimension program of a programming task with a first color on the programming computer and updating a programming progress of the programming task to the verification computer;
displaying an ineligible dimension program of the programming task with a second color on the programming computer and generating a notice indicating that the programming task needs to be reprogrammed;
integrating the eligible dimension programs to generate a 3D coordinate measurement program of the product when all the programming tasks are accomplished;
sending the 3D coordinate measurement program to each of the programming computers for checking validity of the 3D coordinate measurement program;
transferring a validity check result of the 3D coordinate measurement program from each of the programming computers to the verification computer; and
storing the 3D coordinate measurement program into a storage device of the cloud server when the validity check results from the programming computers are approved by the verification computer.

14. The storage medium according to claim 13, wherein the method further comprises:
importing the 3D drawing of a product and the dimension figure of the product to the cloud server.

15. The storage medium according to claim 13, wherein the method further comprises:
receiving a dimension program of each of the programming tasks from each of the programming computers when the programming task is accomplished by the programming computer, and transferring the dimension program to the verification computer through a network.

16. The storage medium according to claim 13, wherein the method further comprises:
determining whether each of the dimension programs is eligible according to the dimension figure of the product.

17. The storage medium according to claim 13, wherein the first color is green or blue, and the second color is yellow or red.

18. The storage medium according to claim 13, wherein the validity check result comprises a dimension of each component of the product, a measurement path for measuring the product, and a collision simulation for measuring the product.
